(19) United States
(12) Patent Application Publication
(10) Pub. No.: US 2020/0264687 A1
(43) Pub. Date: Aug. 20, 2020

(54) INFORMATION PROCESSING APPARATUS AND CONTROL METHOD THEREFOR

(71) Applicant: CANON KABUSHIKI KAISHA, Tokyo (JP)

(72) Inventor: Keigo Goda, Kawasaki-shi (JP)

(21) Appl. No.: 16/784,127

(22) Filed: Feb. 6, 2020

(30) Foreign Application Priority Data
Feb. 15, 2019 (JP) 2019-025329

(51) Int. Cl. G06F 1/3234

(52) U.S. Cl. CPC G06F 1/3268

(57) ABSTRACT

An apparatus includes a storage, a connection unit that can transition to a first state where a command is receivable, a second state where a command is receivable and power saving is greater than in the first state, and a third state where the power saving is greater in the second state, and a control unit that can output a command to the connection unit. The control unit transmits to the connection unit a predetermined command for transiting the connection unit to the second state without supplying power to the storage, based on a predetermined return factor accepted in a power saving state where the connection unit is in the third power state and the power supply to the storage is stopped.

### BACKGROUND OF THE INVENTION

### Field of the Invention

The aspect of the embodiments relates to an information processing apparatus that enables a connection unit, which controls a storage, to make a transition to the power saving state, at a time of return from a power saving state, and a control method therefor.

### Description of the Related Art

A conventional image processing apparatus has a configuration where a storage device, such as a hard disk or a solid state drive (SSD), is connected to the apparatus via a serial advanced technology attachment (SATA) bridge.

Japanese Patent Application Laid-Open No. 2018-15914 discusses an image processing apparatus that includes a storage device, which is connected with an SATA bridge and is turned on only during use.

In the image processing apparatus discussed in Japanese Patent Application Laid-Open No. 2018-15914, a host interface causes the SATA bridge to make a transition to a power saving state conforming to the SATA standard in response to an instruction from a main central processing unit (CPU). The power saving state includes, for example, a device sleep (hereinafter, “DevSleep”) state. At this time, the SATA bridge turns off the storage device. Further, the image processing apparatus discussed in Japanese Patent Application Laid-Open No. 2018-15914 detects access to the storage device from the main CPU based on a command received by the SATA bridge. As a result, the SATA bridge turns on the storage device.

In a case where a user does not operate the image processing apparatus for a certain length of time, the image processing apparatus makes a transition from a normal state to a power saving state to save the power. In the power saving state, the power is generally saved as much as possible by bringing most parts, such as the storage device and the SATA bridge, of the image processing apparatus into an unenergized state.

The image processing apparatus in the power saving state returns from the power saving state to the normal state in response to a user's switch operation and communication from a network. At this time, the storage device is not always used just after the image processing apparatus returns to the normal state. For this reason, from a viewpoint of the power saving, it may be desirable that the image processing apparatus has a function of returning the apparatus from the power saving state to the normal state while the storage device is off.

The image processing apparatus in Japanese Patent Application Laid-Open No. 2018-15914 can return from the power saving state to the normal state while the storage device is off. However, the SATA bridge has to be brought into an energized state when the image processing apparatus in Japanese Patent Application Laid-Open No. 2018-15914 returns from the power saving state to the normal state. This is because, in conventional techniques, although the storage device is turned on based on a command received by the SATA bridge, the SATA bridge can receive the command only in the energized state.

Also in the conventional techniques, the SATA bridge has a function of a transition to an unenergized state, and thus is brought into the unenergized state simultaneously when the storage device, which is on, is turned off.

However, the SATA bridge itself, which is off, is turned on when the image processing apparatus returns from the power saving state to the normal state. Accordingly, the power state also returns to the normal state, which is an initial state, and thus the SATA bridge is not brought into the power saving state.

In the conventional techniques, when the image processing apparatus returns from the power saving state to the normal state, the SATA bridge uselessly consumes power even if the storage device is off. Thus, power consumption cannot be sufficiently reduced. Therefore, the state after the image processing apparatus returns from the power saving state to the normal state is occasionally maintained for a long time depending on a use environment of the image processing apparatus. Thus, the conventional techniques have an issue of the power saving.

### SUMMARY OF THE INVENTION

According to an aspect of the embodiments, an apparatus includes a storage that stores image data, a connection unit that transitions to a first state where a command is receivable, a second state where a command is receivable and power saving is greater than in the first state, and a third state where the power saving is greater than in the second state, a control unit that outputs a command to the connection unit, and a power control unit that controls power supply to the storage. The control unit transmits to the connection unit a predetermined command for transiting the connection unit to the second state without supplying power to the storage, based on a predetermined return factor accepted in a power saving state where the connection unit is in the third power state and the power supply to the storage is stopped. The connection unit transitions to the second state based on the predetermined command

Further features of the disclosure will become apparent from the following description of exemplary embodiments with reference to the attached drawings.

### BRIEF DESCRIPTION OF THE DRAWINGS

FIG. 1 is a block diagram of an image formation apparatus.

FIG. 2 is a power supply block diagram of the image formation apparatus.

FIG. 3 is a block diagram of a serial advanced technology attachment (SATA) bridge.

FIG. 4 is a flowchart illustrating power saving control over the SATA bridge.

FIG. 5 is a flowchart illustrating a transition of the image formation apparatus to a power saving state.

FIGS. 6A and 6B are flowcharts illustrating a return of the image formation apparatus from the power saving state.

FIGS. 7A to 7D are power supply state diagrams of the image formation apparatus in respective power states.

### DESCRIPTION OF THE EMBODIMENTS

An exemplary embodiment of the disclosure will be described below with reference to the drawings. Note that the exemplary embodiment, described below, does not limit the disclosure described in claims. Further, not all combinations of features described below in the exemplary embodiment are essential for the solving means of the disclosure.

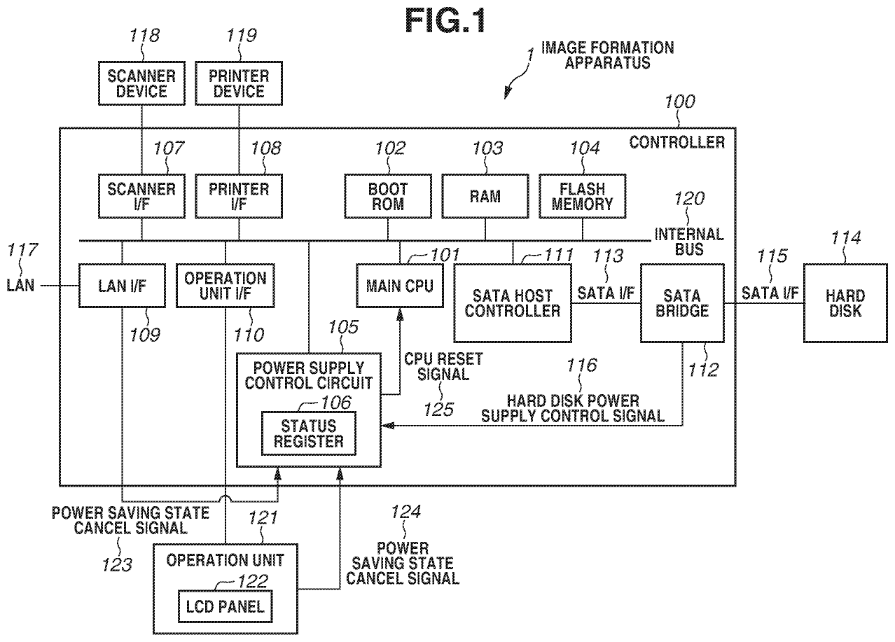

FIG. 1 is a block diagram illustrating a system configuration of an image formation apparatus 1 according to the present exemplary embodiment of the disclosure. In the present exemplary embodiment, as the image formation apparatus 1, an image formation apparatus (multifunction peripheral [MFP]) having a plurality of functions, such as a printing function and a scanning function, is used.

The image formation apparatus 1 includes modules such as a controller 100, a hard disk 114, a scanner device 118, a printer device 119, and an operation unit 121.

The hard disk 114 stores image data such as digital images and a control program. The scanner device 118 optically reads an image from a document and converts the read image into a digital image. The printer device 119 outputs the digital image to a paper device. The operation unit 121 accepts a user's operation on the image formation apparatus 1. The controller 100 is connected with these modules, and issues instructions to the modules to execute jobs in the image formation apparatus 1.

The image formation apparatus 1 receives and outputs a digital image from and to an external apparatus such as a computer connected with a network, via the network such as a local area network (LAN 117). Further, the image formation apparatus 1 accepts a job, and issues an instruction for the image formation apparatus 1 from the external apparatus via the network.

The controller 100 is a so-called central processing unit (CPU) system for general purpose. The controller 100 includes a main CPU 101, a boot read only memory (ROM) 102, and a random access memory (RAM) 103 which are connected with each other via an internal bus 120. The main CPU 101 controls the entire apparatus. The boot ROM 102 contains an initial program called a basic input/output system (BIOS). The RAM 103 is used as a main storage memory by the main CPU 101. Further, the internal bus 120 is connected with a flash memory 104 that is a nonvolatile memory and with a serial advanced technology attachment (SATA) host controller 111 that controls data input and output into and from the hard disk 114.

The flash memory 104 stores firmware that is executed by the main CPU 101 to operate the image formation apparatus 1. The firmware is loaded into the RAM 103 by the BIOS at the activation of the image formation apparatus 1 and is executed by the main CPU 101. Furthermore, the controller 100 is connected with the scanner device 118 via a scanner interface (I/F) 107, and with the printer device 119 via a printer I/F 108. The controller 100 is further connected with the LAN 117 via a LAN I/F 109, and with the operation unit 121 via an operation unit I/F 110.

The operation unit 121 includes a liquid crystal display (LCD) panel 122 used for displaying various kinds of information for a user, and operation buttons, not illustrated, that accept user's operations.

The SATA host controller 111 is a control circuit that is connected with a storage device conforming to the SATA standard and can control input and output of data into and from the storage device. The controller 100 according to the present exemplary embodiment is connected with the hard disk 114 conforming to the SATA standard via the SATA bridge 112.

The SATA bridge 112 is a connection circuit that relays communication conforming to the SATA standard between the SATA host controller 111 and the hard disk 114. The SATA bridge 112 is configured by an application-specific integrated circuit (ASIC).

The SATA host controller 111 and the SATA bridge 112 are connected with each other by an SATA I/F 113, which is a communication I/F conforming to the SATA standard. Similarly, the SATA bridge 112 and the hard disk 114 are connected with each other by an SATA I/F 115, which is a communication I/F conforming to the SATA standard.

The SATA bridge 112 according to the present exemplary embodiment has a power saving function of monitoring the communication between the SATA host controller 111 and the hard disk 114 to control a power supply of the hard disk 114. The SATA bridge 112 further has a power saving function of reducing power to be consumed by itself.

The SATA bridge 112 may has also an additional function other than the power saving functions. The SATA bridge 112 according to the present exemplary embodiment has, for example, a security function of automatically encrypting data to be written into the hard disk 114 by the SATA host controller 111 and automatically decrypting the data to be read.

A power supply control circuit 105 is an electric circuit that controls a power state of the image formation apparatus 1. The main CPU 101 causes the power supply control circuit 105 to control power supply to the respective units of the image formation apparatus 1. As a result, the image formation apparatus 1 is brought into the power saving state, and thus power consumption can be reduced.

Further, the power supply control circuit 105 can cancel the power saving state of the image formation apparatus 1 upon reception of a request from the respective units of the image formation apparatus 1. When receiving any one of power saving state cancel signals 123 and 124, the power supply control circuit 105 resumes the power supply to the respective units, and cancels the power saving state of the image formation apparatus 1.

If detecting a user's operation on the operation buttons, not illustrated, the operation unit 121 outputs the power saving state cancel signal 124. If detecting reception of a network communication packet from an external apparatus via the LAN 117, the LAN OF 109 outputs the power saving state cancel signal 123.

A status register 106 stores energized and unenergized states of the hard disk 114. The main CPU 101 refers to the status register 106 to obtain information about whether the power supply of the hard disk 114 is in the normal state or the unenergized state.

A hard disk power supply control signal 116 is a signal to be used when the SATA bridge 112 causes the hard disk 114 to be turned on or off. Upon reception of the request for turning on or off the hard disk 114 via the hard disk power supply control signal 116, the power supply control circuit 105 controls the energized and unenergized states of the hard disk 114.

A CPU reset signal 125 is a reset signal to be used when the power supply control circuit 105 resets the main CPU 101.

In the present exemplary embodiment, the power saving state cancel signals 123 and 124 are input into the power supply control circuit 105 via a signal line other than the internal bus 120. However, this configuration is an example and thus does not limit the aspect of the embodiments. The signals for requesting the cancel of the power saving state may be transmitted to the power supply control circuit 105 via the internal bus 120.

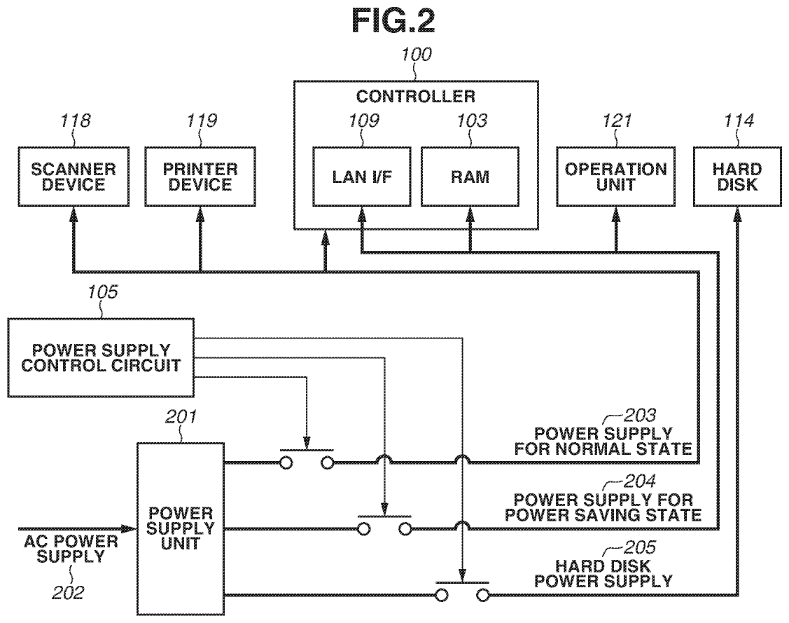

FIG. 2 is a diagram illustrating a power supply configuration of the image formation apparatus 1.

A power supply unit 201 supplies power to the respective units of the image formation apparatus 1 from an input alternating current (AC) power supply 202. In the drawing, thin lines with arrows extended from the power supply control circuit 105 indicate signal lines. Further, thick lines with arrows extended from the power supply unit 201 indicate power supply lines.

A power supply 204 for a power saving state supplies power to a portion where the energized state is maintained also during the power saving state of the image formation apparatus 1. A power supply 203 for a normal state supplies power to a portion which is energized only during the normal state of the image formation apparatus 1. The power supply 203 for a normal state energizes no portion during the power saving state of the image formation apparatus 1. A hard disk power supply 205 supplies power to the hard disk 114. The hard disk power supply 205 does not supply power during the power saving state of the image formation apparatus 1. However, the energized and unenergized states are controlled based on the hard disk power supply control signal 116 during the normal state.

The power supply control circuit 105 individually controls the on and off states of the power supplies 203, 204, and 205.

Note that the configurations of the power supplies are examples and thus do not limit the aspect of the embodiments.

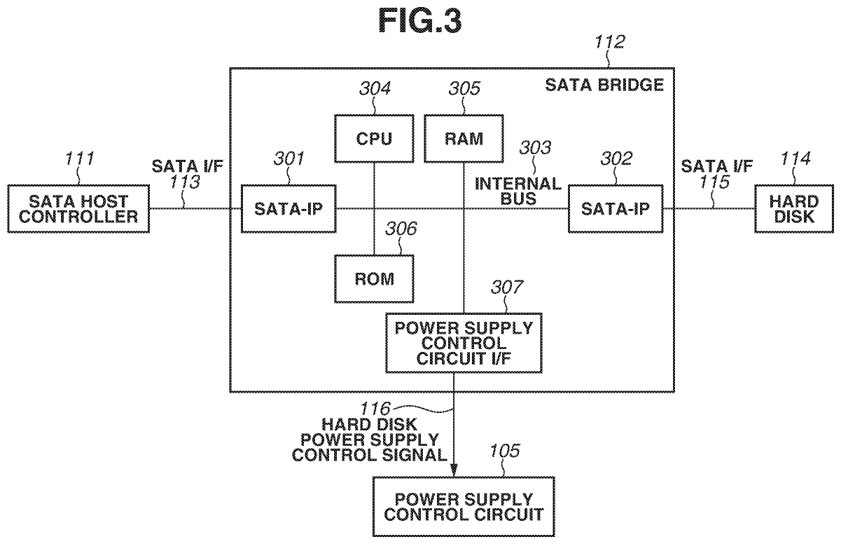

FIG. 3 is a block diagram describing an internal configuration of the SATA bridge 112 which is an ASIC.

The SATA bridge 112 is connected with the SATA host controller 111 via an SATA-Intellectual Property (IP) 301 and with the hard disk 114 via an SATA-IP 302. As a result, the SATA bridge 112 relays the communication between the SATA host controller 111 and the hard disk 114.

The SATA-IP 301 and the SATA-IP 302 are circuits that execute communication processing, conforming to the SATA standard, between devices including a physical layer and a logical layer. The SATA-IP 301 and the SATA-IP 302 transmit and receive a control signal called an out-of-band (00B) signal and an advance technology attachment (ATA) command

The connection inside the SATA bridge 112 is achieved by an internal bus 303. The internal bus 303 is connected with a CPU 304, a RAM 305, a ROM 306, and a power supply control circuit OF 307 as well as the SATA-IP 301 and the SATA-IP 302.

The CPU 304 is a processor that controls an operation of the SATA bridge 112. The CPU 304 transmits the ATA command received by the SATA-IP 301 from the SATA-IP 302, and relays the communication between the SATA host controller 111 and the hard disk 114. Further, the CPU 304 encrypts and decrypts data to be written or loaded from the SATA host controller 111 into the hard disk 114.

The RAM 305 is a work memory to be used when the CPU 304 encrypts and decrypts data. The ROM 306 stores a program to be executed by the CPU 304 to achieve the encrypting and decrypting operations.

Further, the SATA bridge 112 has a power saving function of controlling the power supply control circuit 105 via the hard disk power supply control signal 116 to turn on or off the hard disk power supply 205 and thus saving power. Simultaneously, the SATA bridge 112 has a power saving function of saving power to be consumed by itself.

In the SATA-IP 301 and the SATA-IP 302, the power consumption can be saved through power gating for only partially bringing the ASIC into the unenergized state. The SATA host controller 111 controls the energized and unenergized states of the SATA-IP 301 using a device sleep (DevSleep) state defined by the SATA standard.

In the DevSleep state, control signals including a DevSlee transition signal and a DevSleep cancel signal are transmitted from the SATA host controller 111 to the SATA-IP 301 via an SATA OF 113. Accordingly, upon reception of the DevSleep transition signal, the SATA-IP 301 is brought into the unenergized state. Upon reception of the DevSleep cancel signal, the SATA-IP 301 is brought into the energized state. The circuit is configured in such a manner

On the other hand, the CPU 304 controls the energized and unenergized states of the SATA-IP 302.

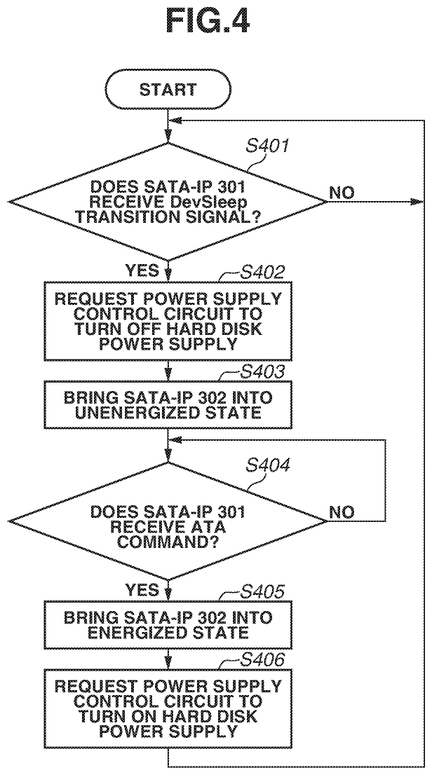

FIG. 4 is a flowchart describing the power saving function of the SATA bridge 112. The flowchart is achieved by the CPU 304 executing the program stored in the ROM 306. The CPU 304 repeats the processing in the flowchart to make the power saving control after the SATA bridge 112 is turned on.

In an initial state just after the SATA bridge 112 is turned on, all the circuits in the SATA bridge 112 are energized and the power consumption is not reduced.

First, in step S401, the CPU 304 waits for the SATA-IP 301 to receive the DevSleep transition signal. The CPU 304 then checks whether the SATA-IP 301 receives the DevSleep transition signal.

If the SATA-IP 301 receives the DevSleep transition signal (YES in step S401), the processing proceeds to step S402. If not (NO in step S401), the CPU 304 repeats the processing in step S401.

In the image formation apparatus 1 according to the present exemplary embodiment, in a case where reading or writing is not performed on the hard disk 114 for a certain length of time, the main CPU 101 controls the SATA host controller 111 to transmit the DevSleep transition signal. Further, before the reading or writing on the hard disk 114, the main CPU 101 controls the SATA host controller 111 to transmit the DevSleep cancel signal.

If the SATA-IP 301 receives the DevSleep transition signal, in step S402, the CPU 304 controls the power supply control circuit I/F 307 to request the power supply control circuit 105 via the hard disk power supply control signal 116 to turn off the hard disk power supply 205. The power supply control circuit 105 controls the hard disk power supply 205 to be turned off if the hard disk power supply 205 is on at that time. As a result, the hard disk 114 is brought into the unenergized state.

In step S403, the CPU 304 then brings the SATA-IP 302 into the unenergized state through power gating. As a result, the power consumption of the hard disk 114 and the SATA bridge 112 can be reduced. As described above, the energized state of the SATA-IP 301 is in conjunction with the reception of the DevSleep transition signal, and thus the power consumption of the SATA-IP 301 can be also reduced. As a result, some of the circuits in the SATA bridge 112 are in the unenergized state, and the SATA bridge 112 is brought into a sleep state.

In step S404, the CPU 304 then waits for the SATA-IP 301 to receive the ATA command from the SATA host controller 111. The CPU 304 then checks whether the SATA-IP 301 receives the ATA command.

If the SATA-IP 301 receives the ATA command (YES in step S404), the reading and writing have to be performed on the hard disk 114, and thus the processing proceeds to step S405. If not (NO in step S404), the CPU 304 repeats the processing in step S404.

In step S405, the CPU 304 returns the SATA-IP 302 to the energized state.

In step S406, the CPU 304 then controls the power supply control circuit I/F 307 to request the power supply control circuit 105 via the hard disk power supply control signal 116 to turn on the hard disk power supply 205. The power supply control circuit 105 then turns on the hard disk power supply 205. As a result, the hard disk 114 is brought into the energized state, thus enabling the reading and writing on the hard disk 114.

When the hard disk 114 is in the energized state, the processing returns to step S401, and the CPU 304 repeats the above-described processing.

The flowchart can achieve the power saving function of the SATA bridge 112 itself.

An operation to be performed by the main CPU 101 to achieve the above-described power saving function of the SATA bridge 112 will be described below.

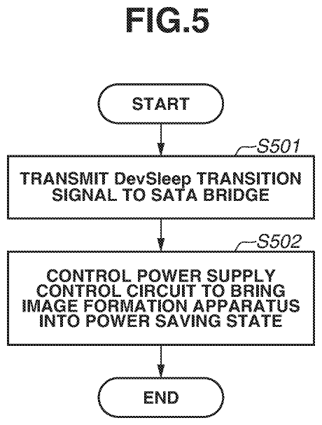

FIG. 5 is a flowchart describing an operation to be performed when the image formation apparatus 1 makes a transition from the normal state to the power saving state. The image formation apparatus 1 according to the present exemplary embodiment is configured to make a transition to the power saving state to save the power consumption in a case where the image formation apparatus 1 does not execute a job for a certain length of time.

The main CPU 101 starts executing the flowchart in a case where the image formation apparatus 1 does not execute a job for a certain length of time.

First, in step S501, the main CPU 101 controls the SATA host controller 111 to transmit the DevSleep transition signal to the SATA bridge 112. Upon reception of the DevSleep transition signal, the SATA bridge 112 controls the hard disk power supply control signal 116. Thus, the power supply control circuit 105 turns off the hard disk power supply 205.

As described above, the main CPU 101 transmits the DevSleep transition signal if a state where the reading and writing are not performed on the hard disk 114 for a certain length of time continues. For this reason, the hard disk power supply 205 has been already turned off in some cases just when the processing in step S501 is executed. In this case, even if the processing in step S501 is executed, the power state of the image formation apparatus 1 does not change.

Thereafter, in step S502, the main CPU 101 controls the power supply control circuit 105 to turn off the power supply 203 for a normal state to stop the power supply to the respective units of the image formation apparatus 1.

At this time, the supply by the power supply 204 for a power saving state is maintained. For this reason, the RAM 103 is maintained in the energized state. Thus, the main CPU 101 can resume the execution of the firmware stored in the RAM 103 immediately at the time of the return from the power saving state. The main CPU 101 then stops the operation to complete the transition of the image formation apparatus 1 to the power saving state.

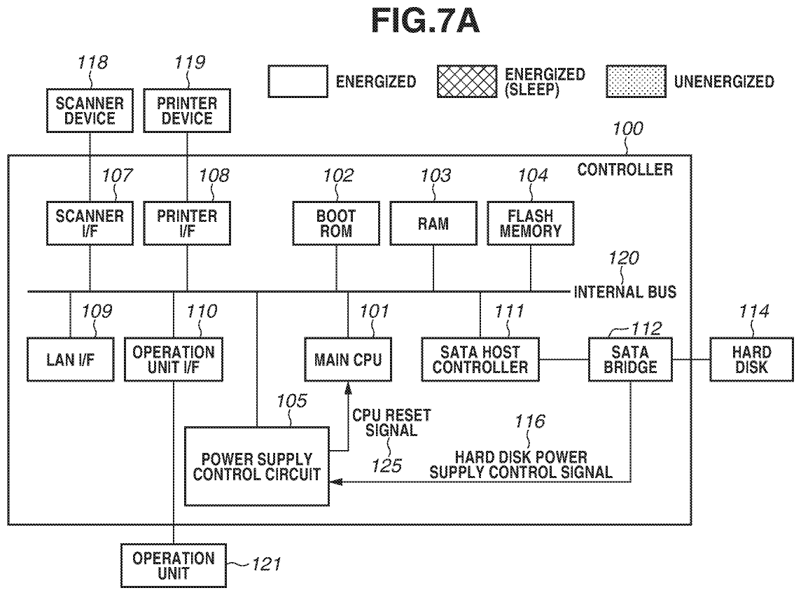

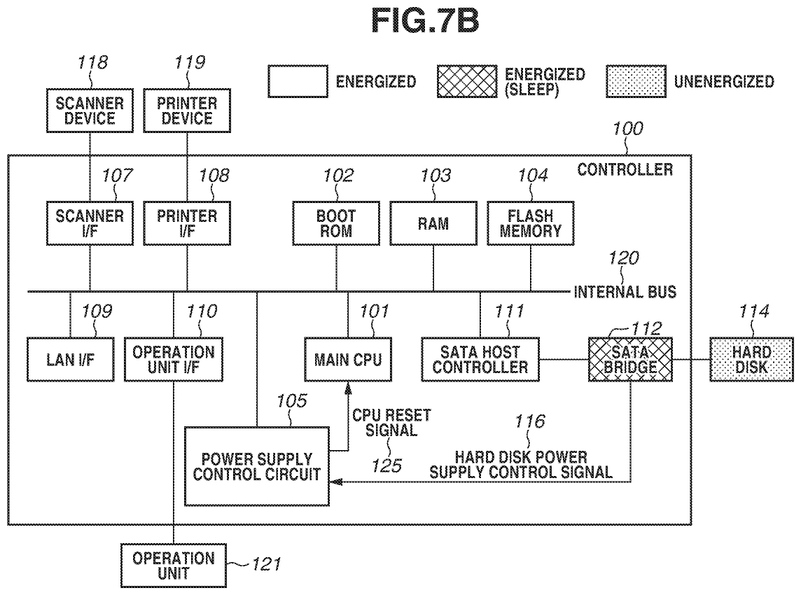

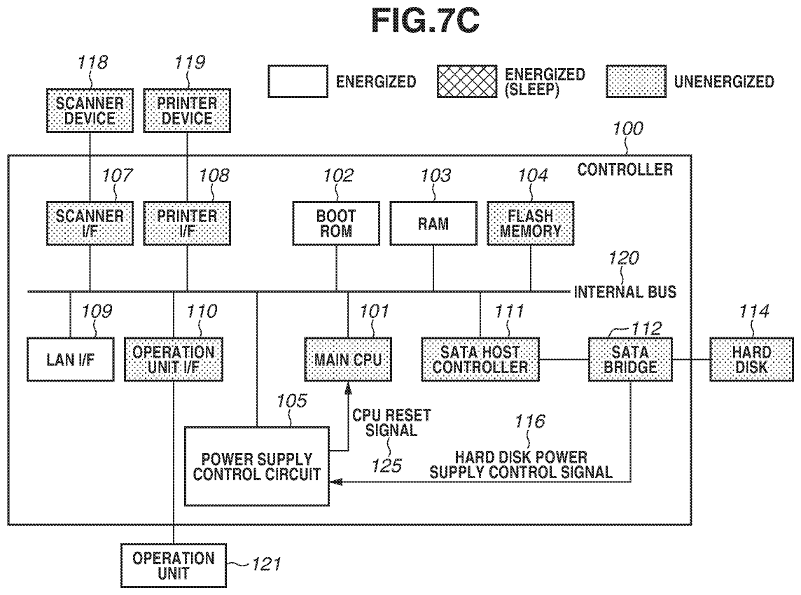

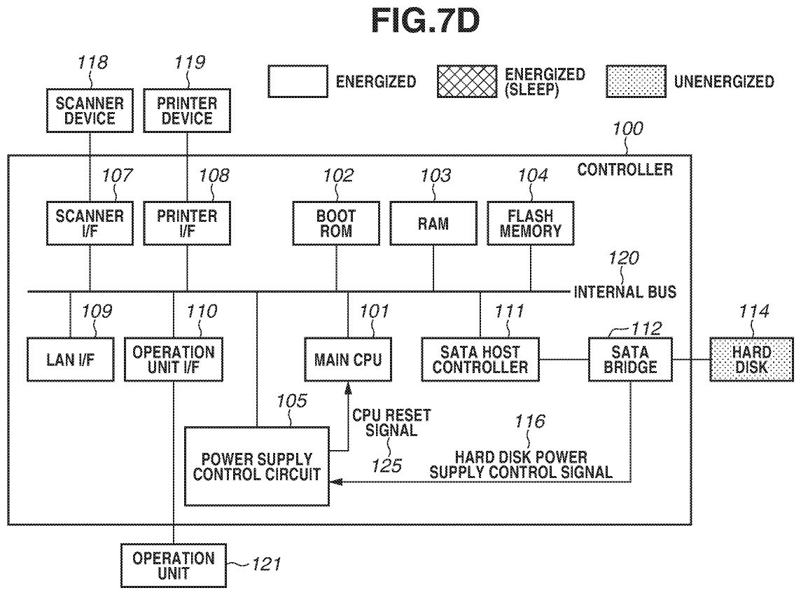

The power state of the image formation apparatus 1 at the moment of the completion of the flowchart in FIG. 5 is as illustrated in FIG. 7C (power saving state).

An operation to be performed when the image formation apparatus 1 returns from the power saving state to the normal state (return operation) will be described below.

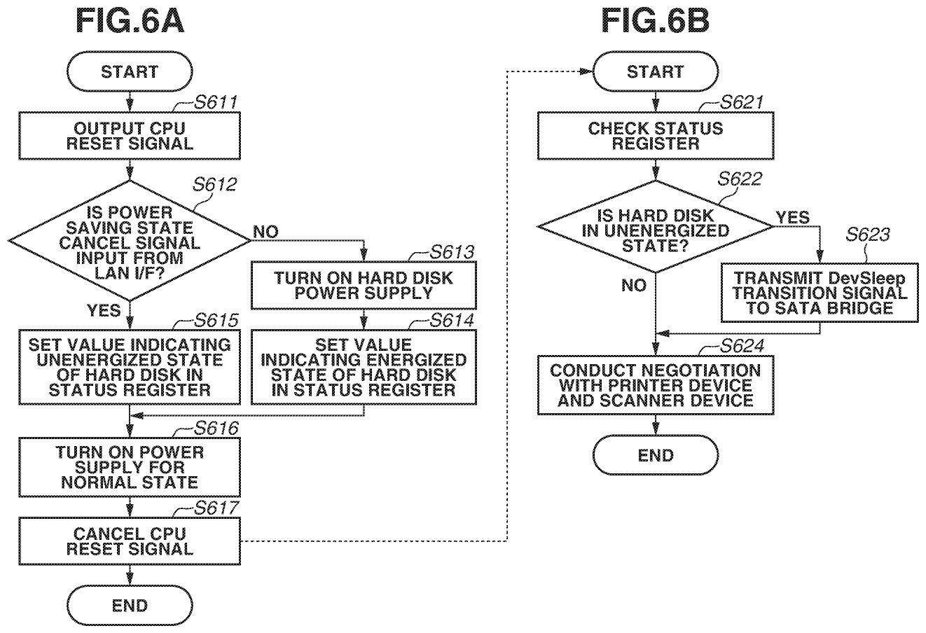

FIGS. 6A and 6B are flowcharts illustrating operations of the power supply control circuit 105 and the main CPU 101 to be performed when the power saving state of the image formation apparatus 1 is cancelled by inputting the power saving state cancel signal 123 or 124 from the operation unit 121 or the LAN I/F 109. FIG. 6A is the flowchart illustrating the operation to be performed by the power supply control circuit 105. FIG. 6B is the flowchart illustrating the operation to be performed by the main CPU 101.

The flowchart in FIG. 6A starts upon input of the power saving state cancel signal 123 or 124.

First, in step S611, the power supply control circuit 105 outputs the CPU reset signal 125. The main CPU 101 does not start the operation during the input of the CPU reset signal 125.

In step S612, the power supply control circuit 105 determines whether the power saving state cancel signal 123 is input from the LAN I/F 109.

If the power saving state cancel signal 123 is input (YES in step S612), the processing proceeds to step S615. If not (NO in step S612), i.e., the power saving state cancel signal 124 is input from the operation unit 121, the processing proceeds to step S613.

In step S613, i.e., if the operation unit 121 requests the return from the power saving state, the power supply control circuit 105 turns on the hard disk power supply 205. This is because in the case of the request from the operation unit 121, a user is likely to be in front of the image formation apparatus 1 and to intend to start executing a job immediately. The execution of a job involves the reading and writing on the hard disk 114. Thus, responsiveness to a user's operation for instructing the execution of a job can be enhanced by bringing the hard disk 114 into the energized state in advance.

In step S614, the power supply control circuit 105 then sets a value indicating the energized state of the hard disk 114 in the status register 106. The processing then proceeds to step S616.

On the other hand, in step S615, i.e., if the LAN I/F 109 requests the return from the power saving state, the power supply control circuit 105 sets a value indicating the unenergized state of the hard disk 114 in the status register 106. This is because in the case of the request from the LAN I/F 109, the execution of a job does not always start immediately, and thus the hard disk 114 is not energized to place priority on the power saving. The processing then proceeds to step S616.

In step S616, the power supply control circuit 105 turns on the power supply 203 for a normal state to resume the power supply to the respective units of the image formation apparatus 1.

In step S617, the power supply control circuit 105 then cancels the CPU reset signal 125. As a result, the main CPU 101 starts the operation to resume the execution of the firmware stored in the RAM 103.

The flowchart in FIG. 6A executed by the power supply control circuit 105 ends.

The power state of the image formation apparatus 1 at the moment of the completion of the flowchart in FIG. 6A is as illustrated in FIG. 7A in the case where the operation unit 121 cancels the power saving state. The power state is as illustrated in FIG. 7D in the case where the LAN I/F 109 cancels the power saving state.

The flowchart in FIG. 6B to be executed by the main CPU 101 in the operation for returning from the power saving state will be described below. The flowchart in FIG. 6B starts when the CPU reset signal 125 is cancelled in step S617 of the flowchart in FIG. 6A.

First in step S621, the main CPU 101 checks the value of the status register 106 in the power supply control circuit 105.

In step S622, the main CPU 101 then determines whether the hard disk 114 is in the unenergized state, based on the checked value of the status register 106.

If the hard disk 114 is determined to be in the unenergized state (YES in step S622), the processing proceeds to step S623. On the other hand, if the hard disk 114 is determined not to be in the unenergized state, i.e., to be in the energized state (NO in step S622), the processing proceeds to step S624.

In step S623, i.e., if the hard disk 114 is in the unenergized state, the main CPU 101 controls the SATA host controller 111 to transmit the DevSleep transition signal to the SATA bridge 112. Upon reception of the DevSleep transition signal, the SATA bridge 112 makes a transition to the sleep state through the above-described power saving function. The processing then proceeds to step S624.

In step S624, the main CPU 101 conducts a negotiation with the scanner device 118 via the scanner I/F 107. Further, the main CPU 101 conducts a negotiation with the printer device 119 via the printer I/F 108. Thus, the image formation apparatus 1 makes a transition to a job acceptable state, and the operation for returning from the power saving state is completed.

The power state of the image formation apparatus 1 at the moment of the completion of the flowchart in FIG. 6B is as illustrated in FIG. 7A in the case where the operation unit 121 cancels the power saving state. The power state is as illustrated in FIG. 7B in the case where the LAN I/F 109 cancels the power saving state.

As described above, according to the present exemplary embodiment, in the image formation apparatus 1 that is connected with the storage device via the SATA bridge 112, when the image formation apparatus returns from the power saving state with the storage device being in the unenergized state, the SATA bridge 112 can be brought into the power saving state. As a result, unnecessary power consumption by the SATA bridge 112 can be prevented, and thus the power consumption of the image formation apparatus 1 can be saved.

In the present exemplary embodiment, the storage device to be connected with the SATA bridge 112 is the hard disk 114, but this configuration is an example and thus does not limit the aspect of the embodiments. The storage device to be connected with the SATA bridge 112 may be, for example, a device, such as a solid state drive (SSD), other than a hard disk.

Further, in the present exemplary embodiment, as a mechanism where the SATA host controller 111 controls the sleep state of the SATA bridge 112, the DevSleep state conforming to the SATA standard is used. However, this mechanism is an example and does not limit the aspect of the embodiments. For example, a slumber state or a partial state conforming to the SATA standard may be used.

Further, in the present exemplary embodiment, the SATA-IP 301 and the SATA-IP 302 in the SATA bridge 112 are brought into the unenergized state by the power gating. However, this configuration is an example and does not limit the aspect of the embodiments. For example, the power consumption may be reduced by clock gating where clock supply only to a part in the ASIC is stopped.

Further, in the present exemplary embodiment, the status register 106 is a register that stores the energized and unenergized states of the hard disk power supply 205. However, this configuration is an example. The configuration is not limited to the above-described one as long as the main CPU 101 can determine the energized state of the hard disk 114 when the power saving state of the image formation apparatus 1 is cancelled.

For example, a register may be configured to store a power saving mode including the state of the hard disk power supply 205. Alternatively, a register may be configured to store return factor information indicating which of the power saving state cancel signals 123 and 124 is input to cancel the power saving state of the image formation apparatus 1.

### Other Embodiments

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2019-025329, filed Feb. 15, 2019, which is hereby incorporated by reference herein in its entirety.

What is claimed is:

1. An apparatus comprising:
a storage that stores image data;
a connection unit that transitions to a first state where a command is receivable, a second state where a command is receivable and power saving is greater than in the first state, and a third state where the power saving is greater than in the second state;
a control unit that outputs a command to the connection unit; and
a power control unit that controls power supply to the storage,
wherein the control unit transmits to the connection unit a predetermined command for transiting the connection unit to the second state without supplying power to the storage, based on a predetermined return factor accepted in a power saving state where the connection unit is in the third power state and the power supply to the storage is stopped, and
wherein the connection unit transitions to the second state based on the predetermined command.

2. The apparatus according to claim 1,
wherein in the third state, power supply to the connection unit is stopped, and
wherein the power control unit preforms control so as to supply power to the connection unit upon reception of the predetermined return factor, and then the control unit transmits the predetermined command for transiting the connection unit to the second state to the connection unit.

3. The apparatus according to claim 1, wherein the command conforms to a serial advanced technology attachment (SATA) standard.

4. The apparatus according to claim 1, wherein the connection unit receives a command conforming to a serial advanced technology attachment (SATA) standard and transmits the command conforming to the SATA standard.

5. The apparatus according to claim 1, wherein the connection unit includes a reception circuit that receives the command output from the control unit and a transmission circuit that transmits the command to the storage.

6. The apparatus according to claim 5, wherein in the second state, power is supplied to the reception circuit and power supply to the transmission circuit is stopped.

7. The apparatus according to claim 1, wherein the connection unit instructs the power control unit to stop the power supply to the storage, based on the predetermined command received with the power being supplied to the storage.

8. The apparatus according to claim 1, wherein the connection unit in the second state returns to the first state and instructs the power control unit to supply power to the storage, based on a command for access to the storage.

9. The apparatus according to claim 1, further comprising a reception unit that receives data from an outside via a network,
wherein the predetermined return factor includes reception of predetermined data by the reception unit.

10. The apparatus according to claim 1, wherein the power control unit supplies power to the storage upon reception of another return factor accepted in the power saving state.

11. The apparatus according to claim 1, wherein the storage includes a hard disk.

12. The apparatus according to claim 1, further comprising a scanner device or a printer device.

13. The apparatus according to claim 1, further comprising a storage unit that stores a power state of the storage,
wherein the control unit transmits the predetermined command based on the power state of the storage.

14. A control method for an apparatus, the apparatus including a storage that stores image data, a connection unit that transitions to a first state where a command is receivable, a second state where a command is receivable and power saving is greater than in the first state, and a third state where the power saving is greater than in the second state, and a control unit that outputs a command to the connection unit, the method comprising:
transiting the connection unit to a power saving state where the connection unit is the third state and power supply to the storage is stopped;
receiving a predetermined return factor in the power saving state;
transmitting to the connection unit a predetermined command for transiting the connection unit to the second state without supplying power to the storage, upon reception of the predetermined return factor, and
transiting the connection unit to the second state based on the predetermined command

15. The method according to claim 14, further comprising: preforming control so as to supply power to the connection unit upon reception of the predetermined return factor, and then transmitting the predetermined command for transiting the connection unit to the second state to the connection unit,
wherein in the third state, power supply to the connection unit is stopped.

16. The method according to claim 14, wherein the command conforms to a serial advanced technology attachment (SATA) standard.

17. The method according to claim 14, wherein the connection unit receives a command conforming to a serial advanced technology attachment (SATA) standard and transmits the command conforming to the SATA standard.

18. The method according to claim 14, wherein the connection unit includes a reception circuit that receives the command output from the control unit and a transmission circuit that transmits the command to the storage.

19. The method according to claim 14, further comprising instructing to stop the power supply to the storage, based on the predetermined command received with the power being supplied to the storage.

20. The method according to claim 14, further comprising instructing to supply power to the storage, based on a command for access to the storage,
wherein the connection unit in the second state returns to the first state.
